(19) United States
(12) Patent Application Publication
(10) Pub. No.: US 2016/0233546 A1
(43) Pub. Date: Aug. 11, 2016

(54) ELECTROLYTE SOLUTION AND LITHIUM ION BATTERIES USING THE SAME

(71) Applicant: Ningde Amperex Technology Limited, Ningde City (CN)

(72) Inventors: Shaowei Feng, Ningde City (CN); Changlong Han, Ningde City (CN); Chenghua Fu, Ningde City (CN); Yongshou Lin, Ningde City (CN)

(73) Assignee: Ningde Amperex Technology Limited, Ningde City (CN)

(21) Appl. No.: 14/991,804

(22) Filed: Jan. 8, 2016

(30) Foreign Application Priority Data
Feb. 6, 2015 (CN) 201510063236.4

(51) Int. Cl. H01M 10/0567; H01M 10/0568; H01M 10/0525

(52) U.S. Cl. CPC H01M 10/0567; H01M 10/0525; H01M 10/0568; H01M 2300/0025

(57) ABSTRACT

Disclosed in this application is an electrolyte solution, comprising a non-aqueous organic solvent, a lithium salt, and additives, characterized in that the additives comprise a cyclic sulfate ester compound and a naphthalene compound with amino group. When the electrolyte solution is used in lithium ion secondary batteries, the batteries are ensured to have good cycling and storage performances at high temperature, and have the advantages of low swelling during use at high temperature, low internal resistance and good charge and discharge performances at low temperature.

### TECHNICAL FIELD

This application relates to the field of batteries, and particularly to a non-aqueous electrolyte solution and lithium ion batteries using the same.

### BACKGROUND

Lithium ion batteries became available in 1990s, and were rapidly generalized for use in portable electronic products including cellular phones, laptop computers, video cameras, digital cameras, and tablet PCs, due to their high voltage, small size, light weight, high specific energy, absence of memory effect and pollution, low self-discharge rate, long service life, and other advantages.

Recently, with the worldwide depletion of petroleum energy and development of novel energy technologies, rapid progress is made in technology of lithium ion batteries for powering automotive vehicles. Meanwhile, increasingly higher requirements are imposed on the performances of lithium ion secondary batteries. For the purpose of satisfying the requirements for electric vehicles regarding capabilities of long-time operation in a high or low temperature environment and quick charge as well as service life, lithium ion secondary batteries are required to have higher discharge capacity and energy density, and more excellent cycling and storage performances at high temperature and rate characteristics at low temperature.

### SUMMARY OF THE INVENTION

According to an aspect of this application, an electrolyte solution is provided, which is used in a lithium ion battery, whereby the battery is ensured to have good cycling and storage performances at high temperature and have the advantages of low swelling during use at high temperature, low internal resistance and good charge and discharge performances at low temperature.

The electrolyte solution comprises a non-aqueous organic solvent, a lithium salt, and additives, characterized in that the additives comprise:

a cyclic sulfate ester compound; and

a naphthalene compound containing amino group.

The naphthalene compound with amino group is one formed by substituting at least one of the hydrogen atoms on carbon Nos. 1, 2, 3, 4, 5, 6, 7, and 8 of the naphthalene ring with amino group. The amino group is selected from —NH₂, —NHR or —NR₂, in which R is an alkyl group having 1 to 20 carbon atoms.

The carbon atoms on the naphthalene ring are numbered as follows.

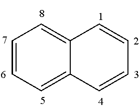

Under the influence of the conjugated system of naphthalene ring, the amino N atom on the naphthalene compound with amino group has a low electron cloud density and weak negative charges, and can undergoes weak coordination and complexation with PF₅, a decomposition product of lithium salt at high temperature, where PF₅ serves as Lewis acid with an electron lacking structure. In this way, the reactivity of PF₅ is reduced and the storage performance of the battery at high temperature is improved (because PF₅ leads to a series of side reactions of the electrolyte solution, and thus deteriorates the storage performance of the battery at high temperature). Moreover, the N atom on the naphthalene compound with amino group also functions to absorb and complex with HF. However, the naphthalene compound with amino group is amenable to oxidation at a high electric potential. The cyclic sulfate ester compound may be reduced on the surface of the negative electrode and oxidized on the surface of the positive electrode to form a dense protective film, which can not only prevent the decomposition of the electrolyte solution through redox reaction, but also prevent the oxidation of the naphthalene compound with amino group on the surface of the positive electrode. The two compounds synergize to significantly improve the storage performance of the battery at high temperature.

Preferably, the cyclic sulfate ester compound is selected from at least one of the compounds having a chemical structure as shown in Formulas I, II, III, and IV:

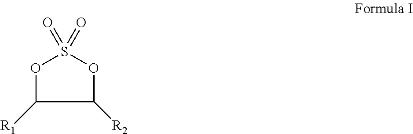

where R₁ is hydrogen or selected from a C₁₋₁₀ alkyl group; and R₂ is hydrogen or selected from a C₁₋₁₀ alkyl group;

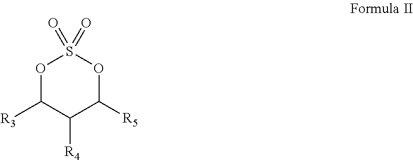

where R₃ is hydrogen or selected from a C₁₋₁₀ alkyl group; R₄ is hydrogen or selected from a C₁₋₁₀ alkyl group; and R₅ is hydrogen or selected from a C₁₋₁₀ alkyl group;

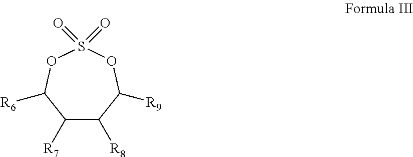

where R₆ is hydrogen or selected from a C₁₋₁₀ alkyl group; R₇ is hydrogen or selected from a C₁₋₁₀ alkyl group; R₈ is hydrogen or selected from a C₁₋₁₀ alkyl group; and R₉ is hydrogen or selected from a C₁₋₁₀ alkyl group; and

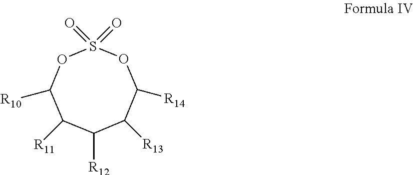

where R₁₀ is hydrogen or selected from a C₁₋₁₀ alkyl group; R₁₁ is hydrogen or selected from a C₁₋₁₀ alkyl group; R₁₂ is hydrogen or selected from a C₁₋₁₀ alkyl group; R₁₃ is hydrogen or selected from a C₁₋₁₀ alkyl group; and R₁₄ is hydrogen or selected from a C₁₋₁₀ alkyl group.

Preferably, the cyclic sulfate ester compound is selected from at least one of the compounds having a chemical structure as shown in Formula I. Further preferably, in Formula I, R₁ is selected from hydrogen, methyl or ethyl, and R₂ is selected from hydrogen, methyl or ethyl.

Preferably, the cyclic sulfate ester compound is selected from at least one of ethylene sulfate, propylene sulfate, and butylene sulfate.

Preferably, the cyclic sulfate ester compound is present in the electrolyte solution in an amount of 0.01-5% by weight. Further preferably, the cyclic sulfate ester compound is present in the electrolyte solution in an amount ranging from an upper limit selected from 5% or 3% to a lower limit selected from 0.1% or 0.5%, by weight.

Preferably, the naphthalene compound with amino group is selected from at least one of the compounds having a chemical structure as shown in Formula V:

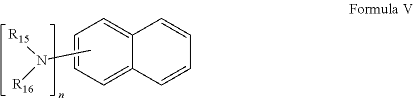

where R₁₅ is selected from a C₁₋₁₀ alkyl group; R₁₆ is selected from a C₁₋₁₀ alkyl group; and n is any positive integer selected from 1 to 8. Further preferably, R₁₅ is selected from a C₁₋₄ alkyl group; and R₁₆ is selected from a C₁₋₄ alkyl group. Further preferably, in Formula V, n=2.

Formula V implies that at least one of the hydrogen atoms on carbon Nos. 1, 2, 3, 4, 5, 6, 7, and 8 of the naphthalene ring is substituted with amino group —NR₁₅R₁₆.

Further preferably, the naphthalene compound with amino group is selected from at least one of the compounds having a chemical structure as shown in Formula VI:

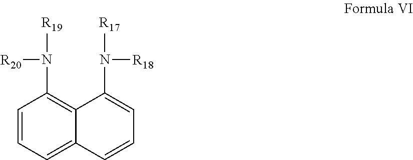

where R₁₇ is selected from a C₁₋₁₀ alkyl group; R₁₈ is selected from a C₁₋₁₀ alkyl group; R₁₉ is selected from a C₁₋₁₀ alkyl group; and R₂₀ is selected from a C₁₋₁₀ alkyl group. Still further preferably, in Formula VI, R₁₇ is selected from a C₁₋₄ alkyl group; R₁₈ is selected from a C₁₋₄ alkyl group; R₁₉ is selected from a C₁₋₄ alkyl group; and R₂₀ is selected from a C₁₋₄ alkyl group.

Preferably, in Formula VI, R₁₇, R₁₈, R₁₉ and R₂₀ are the same group.

Preferably, the naphthalene compound with amino group is selected from at least one of 1,8-bis(dimethylamino)naphthalene, 1,8-bis(diethylamino)naphthalene, 1,8-bis(dipropylamino)naphthalene, 1,2-bis(dimethylamino)naphthalene, 1,7-bis(dimethylamino)naphthalene, 1,2,6-tris(methylamino)naphthalene, 2,3,6,7-tetrakis(methylamino)naphthalene, 1-monoaminonaphthalene, 1,2,3,5,8-pentakis(methylamino)naphthalene, and 1,2,3,4,5,6,7,8-octakis(methylamino)naphthalene. Further preferably, the naphthalene compound with amino group is selected from 1,8-bis(dimethylamino)naphthalene, 1,8-bis(diethylamino)naphthalene, 1,8-bis(dipropylamino)naphthalene, 1,2-bis(dimethylamino)naphthalene, and 1,7-bis(dimethylamino)naphthalene.

Preferably, the naphthalene compound with amino group is present in the electrolyte solution in an amount of 0.01-3% by weight. Further preferably, the naphthalene compound with amino group is present in the electrolyte solution in an amount ranging from an upper limit selected from 3% or 1% to a lower limit selected from 0.03%, 0.1%, or 0.5%, by weight. Still further preferably, the naphthalene compound with amino group is present in the electrolyte solution in an amount of 0.1-3% by weight.

Preferably, the non-aqueous organic solvent comprises a cyclic carbonate. Further preferably, the cyclic carbonate is selected from at least one of ethylene carbonate (EC), propylene carbonate (PC), and butylene carbonate (BC).

Preferably, the non-aqueous organic solvent further comprises at least one of dimethyl carbonate (DMC), diethyl carbonate (DEC), dipropyl carbonate (DPC), methyl ethyl carbonate, methyl propyl carbonate, ethyl propyl carbonate, methyl formate, ethyl formate, propyl formate, methyl acetate, ethyl acetate, propyl acetate, methyl propionate, ethyl propionate, and propyl propionate.

The non-aqueous organic solvent is present in the non-aqueous electrolyte solution in an amount of 75-95% by weight. Further preferably, the non-aqueous organic solvent is present in the non-aqueous electrolyte solution in an amount of 80-90% by weight.

The lithium salt is optionally selected from at least one of an organic lithium salt and an inorganic lithium salt.

Preferably, the lithium salt is selected from at least one of lithium hexafluorophosphate (LiPF₆), lithium tetrafluoroborate (LiBF₄), lithium bis(trifluoromethylsulfonyl)imide (LiN(CF₃SO₂)₂, LiTFSI), lithium bis(fluorosulfonyl)imide (Li(N(SO₂F)₂), LiFSI), lithium bis(oxalato)borate (LiB(C₂O₄)₂, LiBOB), lithium difluoro(oxalato)borate (LiBF₂(C₂O₄), LiDFOB), lithium hexafluoroarsenate (LiAsF₆), lithium perchlorate (LiClO₄), and lithium trifluoromethanesulfonate (LiCF₃SO₃).

Preferably, the lithium salt comprises lithium hexafluorophosphate. Further preferably, the lithium salt is lithium hexafluorophosphate, or is composed of lithium hexafluorophosphate and at least one lithium salt selected from lithium tetrafluoroborate, lithium bis(trifluoromethylsulfonyl)imide, lithium bis(fluorosulfonyl)imide, lithium bis(oxalato)borate, lithium difluoro(oxalato)borate, lithium hexafluoroarsenate (LiAsF₆), lithium perchlorate, and lithium trifluoromethanesulfonate.

The lithium salt is present in the electrolyte solution for lithium ion secondary batteries at a concentration of 0.001-2 M. Preferably, the lithium salt is present in the electrolyte solution at a concentration of 0.5-1.5 M. Further preferably, the lithium salt is present in the electrolyte solution at a concentration of 0.8-1.2 M.

In a preferred embodiment, the additives are composed of the cyclic sulfate ester compound and the naphthalene compound with amino group.

In a preferred embodiment, the electrolyte solution is composed of the non-aqueous organic solvent, the lithium salt and the additives.

According to another aspect of this application, a lithium ion battery is provided, which includes a positive electrode current collector, a positive electrode membrane coated onto the positive electrode current collector, a negative electrode current collector, a negative electrode membrane coated onto the negative electrode current collector, a separator membrane, and an electrolyte solution.

The lithium ion battery is characterized by containing at least one of the above electrolyte solutions.

The lithium ion battery is characterized in that the electrolyte solution is selected from at least one of the above electrolyte solutions.

The positive electrode membrane comprises a positive electrode active material, a binder, and a conductive agent.

The negative electrode membrane comprises a negative electrode active material, a binder, and a conductive agent.

The positive electrode active material is optionally selected from at least one of lithium cobaltate (LiCoO₂), lithium nickelate cobaltate manganate (LiNi_{1/3}Co_{1/3}Mn_{1/3}O₂), lithium manganate (LiMnO₂), and lithium iron phosphate (LiFePO₄).

The negative electrode active material is selected from at least one of natural graphite, artificial graphite, soft carbon, hard carbon, lithium titanate, and silicon.

This application has at least the following beneficial effects:

(1) Both a cyclic sulfate ester compound and a naphthalene compound with amino group are used as additives in the electrolyte solution provided in this application, which synergize, when used in lithium ion batteries, to significantly improve the storage performance and stability at high temperature of the batteries and alleviate the swelling problem of lithium ion batteries at high temperature.

(2) The lithium ion batteries provided in this application have good cycling and storage performances at high temperature.

(3) The lithium ion batteries provided in this application have a low resistance at low temperature.

### Specific Embodiments

The present invention is described in detail by way of examples hereinafter; however, the present invention is not limited thereto.

In the examples, the binder poly(vinylidene fluoride) (PVDF) is purchased from Shenzhen Taineng New Material Co., Ltd.; the thickener sodium carboxymethyl cellulose (CMC) is purchased from Zhengzhou Zhiyi Chemical Product Co., Ltd.; the conductive carbon black Super-P is purchased from Timcal Ltd., Switzerland; the binder styrene butadiene rubber (SBR) is purchased from LG Chemistry Co., Ltd.; and 1,8-bis(dimethylamino)naphthalene, ethylene sulfate, and propylene sulfate are purchased from Zhangjiagang Guotai Huarong Chemical New Material Co., Ltd.

The electrochemical performances of the batteries are determined by using the Autolab Electrochemical Workstation available from Metrohm, Switzerland.

### EXAMPLE 1

Fabrication of Positive Electrode Plate P1^{#}

The positive electrode active material lithium nickelate cobaltate manganate (molecular formula LiNi_{1/3}Co_{1/3}Mn_{1/3}O₂), the conductive agent conductive carbon black Super-P, and the binder poly(vinylidene fluoride) (PVDF, where the content of poly(vinylidene fluoride) is 10% by weight) were uniformly dispersed in the solvent N-methylpyrrolidone (NMP), to prepare a positive electrode slurry. The positive electrode slurry had a solid content of 75 wt %, which was comprised of 96 wt % of lithium nickelate cobaltate manganate, 2% of PVDF and 2 wt % of the conductive carbon black Super-P. The positive electrode slurry was evenly coated in an amount of 0.018 g/cm² onto an aluminium foil with a thickness of 16 μm as a positive electrode current collector, oven dried at 85° C., cold pressed, trimmed, cut, sliced, and then dried for 4 hrs at 85° C. under vacuum and a tab was welded. In this manner, a positive electrode plate was obtained, which was designated as P1^{#}.

Fabrication of Negative Electrode Plate N1^{#}

The negative electrode active material artificial graphite, the conductive agent conductive carbon black Super-P, the thickener sodium carboxymethylcelluose (CMC, where the content of sodium carboxymethylcelluose was 1.5% by weight), the binder styrene-butadiene rubber (SBR, where the content of styrene-butadiene rubber was 50% by weight) were uniformly mixed in deionized water, to prepare a negative electrode slurry. The negative electrode slurry had a solid content of 50 wt %, which was comprised of 96.5 wt % of artificial graphite, 1.0 wt % of the conductive carbon black Super-P, 1.0 wt % of CMC, and 1.5 wt % of SBR. The negative electrode slurry was evenly coated in an amount of 0.0089 g/cm² onto a copper foil with a thickness of 12 μm as a negative electrode current collector, oven dried at 85° C., cold pressed, trimmed, cut, sliced, and then dried for 4 hrs at 110° C. under vacuum, and a tab was welded. In this manner, a negative electrode plate was obtained, which was designated as N1^{#}.

Preparation of Electrolyte Solution L1^{#}

In a dry chamber, ethylene carbonate (EC), methyl ethyl carbonate (EMC), and diethyl carbonate (DEC) were uniformly mixed at a weight ratio of EC:EMC:DEC=30:50:20, to obtain a non-aqueous organic solvent. 1,8-bis(dimethylamino)naphthalene, ethylene sulfate and LiPF₆ were added to the non-aqueous organic solvent, to obtain a solution containing 0.03 wt % of 1,8-bis(dimethylamino)naphthalene, 1 wt % of ethylene sulfate, and 1 mol/L of LiPF₆, that is, the electrolyte solution L1^{#}.

Fabrication of Lithium Ion Secondary Battery C1^{#}

A 12 μm-thick polypropylene film was used as the separator membrane.

The positive electrode plate P1^{#}, the separator membrane, and the negative electrode plate N1^{#} were sequentially laminated, such that the separator membrane was positioned between the positive electrode plate and the negative electrode plate for separation. Then, the laminated structure was wound into a square bare battery core having a thickness of 8 mm, a width of 60 mm, and a length of 130 mm. The bare battery core was packaged in an aluminium foil bag, and then oven dried for 10 hrs at 75° C. under vacuum. The non-aqueous electrolyte solution L1^{#} was filled, packaged under vacuum, and stood for 24 hrs. The battery was charged to 4.2 V at a constant current of 0.1 C (160 mA) and then charged at a constant voltage of 4.2 V until the current dropped to 0.05 C (80 mA), followed by discharge to 3.0 V at a constant current of 0.1 C (160 mA). The charge and discharge process was repeated twice. Finally, the battery was charged to 3.8V at a constant current of 0.1 C (160 mA). In this manner, the fabrication of the lithium ion secondary battery was finished. The obtained lithium ion secondary battery was designated as C1^{#}.

### EXAMPLE 2

Preparation of Electrolyte Solution L2^{#}

The preparation process was the same as that for the electrolyte solution L1^{#}, except that in the electrolyte solution, the content of 1,8-bis(dimethylamino)naphthalene was changed to be 0.1% by weight. The obtained electrolyte solution was designated as L2^{#}.

Fabrication of Lithium Ion Secondary Battery C2^{#}

The fabrication process was the same as that for the lithium ion secondary battery C1^{#}, except that the electrolyte solution L2^{#} was used instead. The obtained lithium ion secondary battery was designated as C2^{#}.

### EXAMPLE 3

Preparation of Electrolyte Solution L3^{#}

The preparation process was the same as that for the electrolyte solution L1^{#}, except that in the electrolyte solution, the content of 1,8-bis(dimethylamino)naphthalene was changed to be 0.5% by weight. The obtained electrolyte solution was designated as L3^{#}.

Fabrication of Lithium Ion Secondary Battery C3^{#}

The fabrication process was the same as that for the lithium ion secondary battery C1^{#}, except that the electrolyte solution L3^{#} was used instead. The obtained lithium ion secondary battery was designated as C3^{#}.

### EXAMPLE 4

Preparation of Electrolyte Solution L4^{#}

The preparation process was the same as that for the electrolyte solution L1^{#}, except that in the electrolyte solution, the content of 1,8-bis(dimethylamino)naphthalene was changed to be 1% by weight. The obtained electrolyte solution was designated as L4^{#}.

Fabrication of Lithium Ion Secondary Battery C4^{#}

The fabrication process was the same as that for the lithium ion secondary battery C1^{#}, except that the electrolyte solution L4^{#} was used instead. The obtained lithium ion secondary battery was designated as C4^{#}.

### EXAMPLE 5

Preparation of Electrolyte Solution L5^{#}

The preparation process was the same as that for the electrolyte solution L1^{#}, except that in the electrolyte solution, the content of 1,8-bis(dimethylamino)naphthalene was changed to be 3% by weight. The obtained electrolyte solution was designated as L5^{#}.

Fabrication of Lithium Ion Secondary Battery C5^{#}

The fabrication process was the same as that for the lithium ion secondary battery C1^{#}, except that the electrolyte solution L5^{#} was used instead. The obtained lithium ion secondary battery was designated as C5^{#}.

### EXAMPLE 6

Preparation of Electrolyte Solution L6^{#}

The preparation process was the same as that for the electrolyte solution L1^{#}, except that in the electrolyte solution, ethylene sulfate was replaced by propylene sulfate. The obtained electrolyte solution was designated as L6^{#}.

Fabrication of Lithium Ion Secondary Battery C6^{#}

The fabrication process was the same as that for the lithium ion secondary battery C1^{#}, except that the electrolyte solution L6^{#} was used instead. The obtained lithium ion secondary battery was designated as C6^{#}.

### EXAMPLE 7

Preparation of Electrolyte Solution L7^{#}

The preparation process was the same as that for the electrolyte solution L6^{#}, except that in the electrolyte solution, the content of 1,8-bis(dimethylamino)naphthalene was changed to be 0.1% by weight. The obtained electrolyte solution was designated as L6^{#}.

Fabrication of Lithium Ion Secondary Battery C7^{#}

The fabrication process was the same as that for the lithium ion secondary battery C1^{#}, except that the electrolyte solution L7^{#} was used instead. The obtained lithium ion secondary battery was designated as C7^{#}.

### EXAMPLE 8

Preparation of Electrolyte Solution L8^{#}

The preparation process was the same as that for the electrolyte solution L6^{#}, except that in the electrolyte solution, the content of 1,8-bis(dimethylamino)naphthalene was changed to be 0.5% by weight. The obtained electrolyte solution was designated as L8^{#}.

Fabrication of Lithium Ion Secondary Battery C8^{#}

The fabrication process was the same as that for the lithium ion secondary battery C1^{#}, except that the electrolyte solution L8^{#} was used instead. The obtained lithium ion secondary battery was designated as C8^{#}.

### EXAMPLE 9

Preparation of Electrolyte Solution L9^{#}

The preparation process was the same as that for the electrolyte solution L6^{#}, except that in the electrolyte solution, the content of 1,8-bis(dimethylamino)naphthalene was changed to be 1% by weight. The obtained electrolyte solution was designated as L9^{#}.

Fabrication of Lithium Ion Secondary Battery C9^{#}

The fabrication process was the same as that for the lithium ion secondary battery C1^{#}, except that electrolyte solution L9^{#} was used instead. The obtained lithium ion secondary battery was designated as C9¹⁹⁰ .

### EXAMPLE 10

Preparation of Electrolyte Solution L10^{#}

The preparation process was the same as that for the electrolyte solution L6^{#}, except that in the electrolyte solution, the content of 1,8-bis(dimethylamino)naphthalene was changed to be 3% by weight. The obtained electrolyte solution was designated as L10^{#}.

Fabrication of Lithium Ion Secondary Battery C10^{#}

The fabrication process was the same as that for the lithium ion secondary battery C1^{#}, except that the electrolyte solution L10^{#} was used instead. The obtained lithium ion secondary battery was designated as C10^{#}.

### EXAMPLE 11

Preparation of Electrolyte Solution L11^{#}

The preparation process was the same as that for the electrolyte solution L1^{#}, except that in the electrolyte solution, the content of 1,8-bis(dimethylamino)naphthalene was changed to be 0.5% by weight, and the content of ethylene sulfate was changed to be 0.1% by weight. The obtained electrolyte solution was designated as L11^{#}.

Fabrication of Lithium Ion Secondary Battery C11^{#}

The fabrication process was the same as that for the lithium ion secondary battery C1^{#}, except that the electrolyte solution L11^{#} was used instead. The obtained lithium ion secondary battery was designated as C11^{#}.

### EXAMPLE 12

Preparation of Electrolyte Solution L12^{#}

The preparation process was the same as that for the electrolyte solution L1^{#}, except that in the electrolyte solution, the content of 1,8-bis(dimethylamino)naphthalene was changed to be 0.5% by weight, and the content of ethylene sulfate was changed to be 0.5% by weight. The obtained electrolyte solution was designated as L12^{#}.

Fabrication of Lithium Ion Secondary Battery C12^{#}

The fabrication process was the same as that for the lithium ion secondary battery C1^{#}, except that the electrolyte solution L12^{#} was used instead. The obtained lithium ion secondary battery was designated as C12^{#}.

### EXAMPLE 13

Preparation of Electrolyte Solution L13^{#}

The preparation process was the same as that for the electrolyte solution L1^{#}, except that in the electrolyte solution, the content of 1,8-bis(dimethylamino)naphthalene was changed to be 0.5% by weight, and the content of ethylene sulfate was changed to be 3% by weight. The obtained electrolyte solution was designated as L13^{#}.

Fabrication of Lithium Ion Secondary Battery C13^{#}

The fabrication process was the same as that for the lithium ion secondary battery C1^{#}, except that the electrolyte solution L13^{#} was used instead. The obtained lithium ion secondary battery was designated as C13^{#}.

### EXAMPLE 14

Preparation of Electrolyte Solution L14^{#}

The preparation process was the same as that for the electrolyte solution L1^{#}, except that in the electrolyte solution, the content of 1,8-bis(dimethylamino)naphthalene was changed to be 0.5% by weight, and the content of ethylene sulfate was changed to be 5% by weight. The obtained electrolyte solution was designated as L14^{#}.

Fabrication of Lithium Ion Secondary Battery C14^{#}

The fabrication process was the same as that for the lithium ion secondary battery C1^{#}, except that the electrolyte solution L14^{#} was used instead. The obtained lithium ion secondary battery was designated as C14^{#}.

### EXAMPLE 15

Preparation of Electrolyte Solution L15^{#}

The preparation process was the same as that for the electrolyte solution L1^{#}, except that in the electrolyte solution, the content of 1,8-bis(dimethylamino)naphthalene was changed to be 0.5% by weight, ethylene sulfate was replaced by butylene sulfate, and butylene sulfate was present in the electrolyte solution in an amount of 1% by weight. The obtained electrolyte solution was designated as L15^{∩}.

Fabrication of Lithium Ion Secondary Battery C15^{#}

The fabrication process was the same as that for the lithium ion secondary battery C1^{#}, except that the electrolyte solution L15^{#} was used instead. The obtained lithium ion secondary battery was designated as C15^{#}.

### EXAMPLE 16

Preparation of Electrolyte Solution L16^{#}

The preparation process was the same as that for the electrolyte solution L3^{#}, except that in the electrolyte solution, 1,8-bis(dimethylamino)naphthalene was replaced by 1,8-bis(diethylamino)naphthalene. The obtained electrolyte solution was designated as L16^{#}.

Fabrication of Lithium Ion Secondary Battery C16^{#}

The fabrication process was the same as that for the lithium ion secondary battery C1^{#}, except that the electrolyte solution L16^{#} was used instead. The obtained lithium ion secondary battery was designated as C16^{#}.

### EXAMPLE 17

Preparation of Electrolyte Solution L17^{#}

The preparation process was the same as that for the electrolyte solution L3^{#}, except that in the electrolyte solution, 1,8-bis(dimethylamino)naphthalene was replaced by 1,8-bis(dipropylamino)naphthalene. The obtained electrolyte solution was designated as L17^{#}.

Fabrication of Lithium Ion Secondary Battery C17^{#}

The fabrication process was the same as that for the lithium ion secondary battery C1^{#}, except that the electrolyte solution L17^{#} was used instead. The obtained lithium ion secondary battery was designated as C17^{#}.

### EXAMPLE 18

Preparation of Electrolyte Solution L18^{#}

The preparation process was the same as that for the electrolyte solution L1^{#}, except that in the electrolyte solution, 1,8-bis(dimethylamino)naphthalene was replaced by 1,2-bis(dimethylamino)naphthalene, and 1,2-bis(dimethylamino)naphthalene was present in the electrolyte solution in an amount of 0.5% by weight. The obtained electrolyte solution was designated as L18^{#}.

Fabrication of Lithium Ion Secondary Battery C18^{#}

The fabrication process was the same as that for the lithium ion secondary battery C1^{#}, except that the electrolyte solution L18^{#} was used instead. The obtained lithium ion secondary battery was designated as C18^{#}.

### EXAMPLE 19

Preparation of Electrolyte Solution L19^{#}

The preparation process was the same as that for the electrolyte solution L1^{#}, except that in the electrolyte solution, 1,8-bis(dimethylamino)naphthalene was replaced by 1,7-bis(dimethylamino)naphthalene, and 1,7-bis(dimethylamino)naphthalene was present in the electrolyte solution in an amount of 0.5% by weight. The obtained electrolyte solution was designated as L19^{#}.

Fabrication of Lithium Ion Secondary Battery C19^{#}

The fabrication process was the same as that for the lithium ion secondary battery C1^{#}, except that the electrolyte solution L19^{#} was used instead. The obtained lithium ion secondary battery was designated as C19^{#}.

### EXAMPLE 20

Preparation of Electrolyte Solution L20^{#}

The preparation process was the same as that for the electrolyte solution L1^{#}, except that in the electrolyte solution, 1,8-bis(dimethylamino)naphthalene was replaced by 1,2,6-tris(methylamino)naphthalene, and 1,2,6-tris(methylamino)naphthalene was present in the electrolyte solution in an amount of 0.5% by weight. The obtained electrolyte solution was designated as L20^{#}.

Fabrication of Lithium Ion Secondary Battery C20^{#}

The fabrication process was the same as that for the lithium ion secondary battery C1^{#}, except that the electrolyte solution L20^{#} was used instead. The obtained lithium ion secondary battery was designated as C20^{#}.

### EXAMPLE 21

Preparation of Electrolyte Solution L21^{#}

The preparation process was the same as that for the electrolyte solution L1^{#}, except that in the electrolyte solution, 1,8-bis(dimethylamino)naphthalene was replaced by 2,3,6,7-tetrakis(methylamino)naphthalene, and 2,3,6,7-tetrakis(methylamino)naphthalene was present in the electrolyte solution in an amount of 0.5% by weight. The obtained electrolyte solution was designated as L21^{#}.

Fabrication of Lithium Ion Secondary Battery C21^{#}

The fabrication process was the same as that for the lithium ion secondary battery C1^{#}, except that the electrolyte solution L21^{#} was used instead. The obtained lithium ion secondary battery was designated as C21^{#}.

### EXAMPLE 22

Preparation of Electrolyte Solution L22^{#}

The preparation process was the same as that for the electrolyte solution L1^{#}, except that in the electrolyte solution, 1,8-bis(dimethylamino)naphthalene was replaced by 1-monoaminonaphthalene, and 1-monoaminonaphthalene was present in the electrolyte solution in an amount of 0.5% by weight. The obtained electrolyte solution was designated as L22^{#}.

Fabrication of Lithium Ion Secondary Battery C22^{#}

The fabrication process was the same as that for the lithium ion secondary battery C1^{#}, except that the electrolyte solution L22^{#} was used instead. The obtained lithium ion secondary battery was designated as C22^{#}.

### EXAMPLE 23

Preparation of Electrolyte Solution L23^{#}

The preparation process was the same as that for the electrolyte solution L1^{#}, except that in the electrolyte solution, 1,8-bis(dimethylamino)naphthalene was replaced by 1,2,3,5,8-pentakis(methylamino)naphthalene, and 1,2,3,5,8-pentakis(methylamino)naphthalene was present in the electrolyte solution in an amount of 0.5% by weight. The obtained electrolyte solution was designated as L23^{#}.

Fabrication of Lithium Ion Secondary Battery C23^{#}

The fabrication process was the same as that for the lithium ion secondary battery C1^{#}, except that the electrolyte solution L23^{#} was used instead. The obtained lithium ion secondary battery was designated as C23^{#}.

### EXAMPLE 24

Preparation of Electrolyte Solution L24^{#}

The preparation process was the same as that for the electrolyte solution L1^{#}, except that in the electrolyte solution, 1,8-bis(dimethylamino)naphthalene was replaced by 1,2,3,4,5,6,7,8-octakis(methylamino)naphthalene, and 1,2,3,4,5,6,7,8-octakis(methylamino)naphthalene was present in the electrolyte solution in an amount of 0.5% by weight. The obtained electrolyte solution was designated as L24^{#}.

Fabrication of Lithium Ion Secondary Battery C24^{#}

The fabrication process was the same as that for the lithium ion secondary battery C1^{#}, except that the electrolyte solution L24^{#} was used instead. The obtained lithium ion secondary battery was designated as C24^{#}.

### COMPARATIVE EXAMPLE 1

Preparation of Electrolyte Solution DL1^{#}

The preparation process was the same as that for the electrolyte solution L1^{#}, except that in the electrolyte solution, no 1,8-bis(dimethylamino)naphthalene and ethylene sulfate were added. The obtained electrolyte solution was designated as DL1^{#}.

Fabrication of Lithium Ion Secondary Battery DC1^{#}

The fabrication process was the same as that for the lithium ion secondary battery C1^{#}, except that the electrolyte solution DLO was used instead. The obtained lithium ion secondary battery was designated as DC1^{#}.

### COMPARATIVE EXAMPLE 2

Preparation of Electrolyte Solution DL2^{#}

The preparation process was the same as that for the electrolyte solution L1^{#}, except that in the electrolyte solution, no 1,8-bis(dimethylamino)naphthalene was added. The obtained electrolyte solution was designated as DL2^{#}.

Fabrication of Lithium Ion Secondary Battery DC2^{#}

The fabrication process was the same as that for the lithium ion secondary battery C1^{#}, except that the electrolyte solution DL2^{#} was used instead. The obtained lithium ion secondary battery was designated as DC2^{#}.

### COMPARATIVE EXAMPLE 3

Preparation of Electrolyte Solution DL3^{#}

The preparation process was the same as that for the electrolyte solution L1^{#}, except that in the electrolyte solution, no 1,8-bis(dimethylamino)naphthalene was added, ethylene sulfate was replaced by propylene sulfate, and propylene sulfate was present in the electrolyte solution in an amount of 1% by weight. The obtained electrolyte solution was designated as DL3^{#}.

Fabrication of Lithium Ion Secondary Battery DC3^{#}

The fabrication process was the same as that for the lithium ion secondary battery Ce, except that the electrolyte solution DL3^{#} was used instead. The obtained lithium ion secondary battery was designated as DC3^{#}.

### COMPARATIVE EXAMPLE 4

Preparation of Electrolyte Solution DL4^{#}

The preparation process was the same as that for the electrolyte solution L1^{#}, except that in the electrolyte solution, the content of 1,8-bis(dimethylamino)naphthalene was changed to be 0.005% by weight. The obtained electrolyte solution was designated as DL4^{#}.

Fabrication of Lithium Ion Secondary Battery DC4^{#}

The fabrication process was the same as that for the lithium ion secondary battery C1^{#}, except that the electrolyte solution DL4^{#} was used instead. The obtained lithium ion secondary battery was designated as DC4^{#}.

### COMPARATIVE EXAMPLE 5

Preparation of Electrolyte Solution DL5^{#}

The preparation process was the same as that for the electrolyte solution L1^{#}, except that in the electrolyte solution, the content of 1,8-bis(dimethylamino)naphthalene was changed to be 5% by weight. The obtained electrolyte solution was designated as DL5^{#}.

Fabrication of Lithium Ion Secondary Battery DC5^{#}

The fabrication process was the same as that for the lithium ion secondary battery C1^{#}, except that the electrolyte solution DL5^{#} was used instead. The obtained lithium ion secondary battery was designated as DC5^{#}.

### COMPARATIVE EXAMPLE 6

Preparation of Electrolyte Solution DL6^{#}

The preparation process was the same as that for the electrolyte solution L1^{#}, except that in the electrolyte solution, the content of 1,8-bis(dimethylamino)naphthalene was changed to be 0.005% by weight, ethylene sulfate was replaced by propylene sulfate, and propylene sulfate was present in the electrolyte solution in an amount of 1% by weight. The obtained electrolyte solution was designated as DL6^{#}.

Fabrication of Lithium Ion Secondary Battery DC6^{#}

The fabrication process was the same as that for the lithium ion secondary battery C1^{#}, except that the electrolyte solution DL6^{#} was used instead. The obtained lithium ion secondary battery was designated as DC6^{#}.

### COMPARATIVE EXAMPLE 7

Preparation of Electrolyte Solution DL7^{#}

The preparation process was the same as that for the electrolyte solution L1^{#}, except that in the electrolyte solution, the content of 1,8-bis(dimethylamino)naphthalene was changed to be 5% by weight, ethylene sulfate was replaced by propylene sulfate, and propylene sulfate was present in the electrolyte solution in an amount of 1% by weight.

The obtained electrolyte solution was designated as DL7^{#}.

Fabrication of Lithium Ion Secondary Battery DC7^{#}

The fabrication process was the same as that for the lithium ion secondary battery C1^{#}, except that the electrolyte solution DL7^{#} was used instead. The obtained lithium ion secondary battery was designated as DC7^{#}.

### COMPARATIVE EXAMPLE 8

Preparation of Electrolyte Solution DL8^{#}

The preparation process was the same as that for the electrolyte solution L1^{#}, except that the content of 1,8-bis(dimethylamino)naphthalene in the electrolyte solution was changed to be 0.5% by weight, and the content of ethylene sulfate in the electrolyte solution was changed to be 0.001% by weight. The obtained electrolyte solution was designated as DL8^{#}.

Fabrication of Lithium Ion Secondary Battery DC8^{#}

The fabrication process was the same as that for the lithium ion secondary battery C1^{#}, except that the electrolyte solution DL8^{#} was used instead. The obtained lithium ion secondary battery was designated as DC8^{#}.

### COMPARATIVE EXAMPLE 9

Preparation of Electrolyte Solution DL9^{#}

The preparation process was the same as that for the electrolyte solution L1^{#} except that the content of 1,8-bis(dimethylamino)naphthalene in the electrolyte solution was changed to be 0.5% by weight, and the content of ethylene sulfate in the electrolyte solution was changed to be 8% by weight. The obtained electrolyte solution was designated as DL9^{#}.

Fabrication of Lithium Ion Secondary Battery DC9^{#}

The fabrication process was the same as that for the lithium ion secondary battery C1^{#}, except that the electrolyte solution DL9^{#} was used instead. The obtained lithium ion secondary battery was designated as DC9^{#}.

### COMPARATIVE EXAMPLE 10

Preparation of Electrolyte Solution DL10^{#}

The preparation process was the same as that for the electrolyte solution L1^{#}, except that in the electrolyte solution, the content of 1,8-bis(dimethylamino)naphthalene was changed to be 0.5% by weight, ethylene sulfate was replaced by vinylene carbonate, and ethylene carbonate was present in the electrolyte solution in an amount of 1% by weight. The obtained electrolyte solution was designated as DL10^{#}.

Fabrication of Lithium Ion Secondary Battery DC10⁴

The fabrication process was the same as that for the lithium ion secondary battery C1^{#}, except that the electrolyte solution DL10^{#} was used instead. The obtained lithium ion secondary battery was designated as DC10^{#}.

### COMPARATIVE EXAMPLE 11

Preparation of Electrolyte Solution DL11^{#}

The preparation process was the same as that for the electrolyte solution L1^{#}, except that in the electrolyte solution, the content of 1,8-bis(dimethylamino)naphthalene was changed to be 0.5% by weight, and no ethylene sulfate was contained. The obtained electrolyte solution was designated as DL11^{#}.

Fabrication of Lithium Ion Secondary Battery DC11^{#}

The fabrication process was the same as that for the lithium ion secondary battery C1^{#}, except that the electrolyte solution DL11^{#} was used instead. The obtained lithium ion secondary battery was designated as DC11^{#}.

### EXAMPLE 25

Preparation of Electrolyte Solution L25⁴

The preparation process was the same as that for the electrolyte solution L1^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L25^{#}.

Fabrication of Lithium Ion Secondary Battery C25^{#}

The fabrication process was the same as that for the lithium ion secondary battery C1^{#}, except that the electrolyte solution L25^{#} was used instead. The obtained lithium ion secondary battery was designated as C25^{#}.

### EXAMPLE 26

Preparation of Electrolyte Solution L26^{#}

The preparation process was the same as that for the electrolyte solution L2^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L26^{#}.

Fabrication of Lithium Ion Secondary Battery C26^{#}

The fabrication process was the same as that for the lithium ion secondary battery C1^{#}, except that the electrolyte solution L26^{#} was used instead. The obtained lithium ion secondary battery was designated as C26^{#}.

### EXAMPLE 27

Preparation of Electrolyte Solution L27^{#}

The preparation process was the same as that for the electrolyte solution L3^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L27^{#}.

Fabrication of Lithium Ion Secondary Battery C27^{#}

The fabrication process was the same as that for the lithium ion secondary battery C1^{#}, except that the electrolyte solution L27^{#} was used instead. The obtained lithium ion secondary battery was designated as C27^{#}.

### EXAMPLE 28

Preparation of Electrolyte Solution L28^{#}

The preparation process was the same as that for the electrolyte solution L4^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L28^{#}.

Fabrication of Lithium Ion Secondary Battery C28^{#}

The fabrication process was the same as that for the lithium ion secondary battery C1^{#}, except that the electrolyte solution L28^{#} was used instead. The obtained lithium ion secondary battery was designated as C28^{#}.

### EXAMPLE 29

Preparation of Electrolyte Solution L29^{#}

The preparation process was the same as that for the electrolyte solution L5^{#}, except that LiPF₆ was replaced by a mixture LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L29^{#}.

Fabrication of Lithium Ion Secondary Battery C29^{#}

The fabrication process was the same as that for the lithium ion secondary battery C1^{#}, except that the electrolyte solution L29^{#} was used instead. The obtained lithium ion secondary battery was designated as C29^{#}.

### EXAMPLE 30

### Preparation of Electrolyte Solution L30^{#}

The preparation process was the same as that for the electrolyte solution L6^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as L30^{#}.

Fabrication of Lithium Ion Secondary Battery C30^{#}

The fabrication process was the same as that for the lithium ion secondary battery C1^{#}, except that the electrolyte solution L30^{#} was used instead. The obtained lithium ion secondary battery was designated as C30^{#}.

### EXAMPLE 31

Preparation of Electrolyte Solution L31^{#}

The preparation process was the same as that for the electrolyte solution L7^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as L31^{#}.

Fabrication of Lithium Ion Secondary Battery C31^{#}

The fabrication process was the same as that for the lithium ion secondary battery C1^{#}, except that the electrolyte solution L31^{#} was used instead. The obtained lithium ion secondary battery was designated as C31^{#}.

### EXAMPLE 32

Preparation of Electrolyte Solution L32^{#}

The preparation process was the same as that for the electrolyte solution L8^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as L32^{#}.

Fabrication of Lithium Ion Secondary Battery C32^{#}

The fabrication process was the same as that for the lithium ion secondary battery C1^{#}, except that the electrolyte solution L32^{#}. The obtained lithium ion secondary battery was designated as C32^{#}.

### EXAMPLE 33

Preparation of Electrolyte Solution L33^{#}

The preparation process was the same as that for the electrolyte solution L9^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as L33^{#}.

Fabrication of Lithium Ion Secondary Battery C33^{#}

The fabrication process was the same as that for the lithium ion secondary battery C1^{#}, except that the electrolyte solution L33^{#} was used instead. The obtained lithium ion secondary battery was designated as C33^{#}.

### EXAMPLE 34

Preparation of Electrolyte Solution L34^{#}

The preparation process was the same as that for the electrolyte solution L10^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as L34^{#}.

Fabrication of Lithium Ion Secondary Battery C34^{#}

The fabrication process was the same as that for the lithium ion secondary battery C1^{#}, except that the electrolyte solution L34^{#} was used instead. The obtained lithium ion secondary battery was designated as C34^{#}.

### EXAMPLE 35

Preparation of Electrolyte Solution L35^{#}

The preparation process was the same as that for the electrolyte solution L11^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L35^{#}.

Fabrication of Lithium Ion Secondary Battery C35^{#}

The fabrication process was the same as that for the lithium ion secondary battery C1^{#}, except that the electrolyte solution L35^{#} was used instead. The obtained lithium ion secondary battery was designated as C35^{#}.

### EXAMPLE 36

Preparation of Electrolyte Solution L36^{#}

The preparation process was the same as that for the electrolyte solution L12^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L36^{#}.

Fabrication of Lithium Ion Secondary Battery C36^{#}

The fabrication process was the same as that for the lithium ion secondary battery C1^{#}, except that the electrolyte solution L36^{#} was used instead. The obtained lithium ion secondary battery was designated as C36^{#}.

### EXAMPLE 37

Preparation of Electrolyte Solution L37^{#}

The preparation process was the same as that for the electrolyte solution L13^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L37^{#}.

Fabrication of Lithium Ion Secondary Battery C37^{#}

The fabrication process was the same as that for the lithium ion secondary battery C1^{#}, except that the electrolyte solution L37^{#} was used instead. The obtained lithium ion secondary battery was designated as C37^{#}.

### EXAMPLE 38

Preparation of Electrolyte Solution L38^{#}

The preparation process was the same as that for the electrolyte solution L14^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L38^{#}.

Fabrication of Lithium Ion Secondary Battery C38^{#}

The fabrication process was the same as that for the lithium ion secondary battery C1^{#}, except that the electrolyte solution L38^{#} was used instead. The obtained lithium ion secondary battery was designated as C38^{#}.

### EXAMPLE 39

Preparation of Electrolyte Solution L39^{#}

The preparation process was the same as that for the electrolyte solution L15^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as L39^{#}.

Fabrication of Lithium Ion Secondary Battery C39^{#}

The fabrication process was the same as that for the lithium ion secondary battery C1^{#}, except that the electrolyte solution L39^{#} was used instead. The obtained lithium ion secondary battery was designated as C39^{#}.

### COMPARATIVE EXAMPLE 12

Preparation of Electrolyte Solution DL12^{#}

The preparation process was the same as that for the electrolyte solution DL1^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL12^{#}.

Fabrication of Lithium Ion Secondary Battery DC12^{#}

The fabrication process was the same as that for the lithium ion secondary battery C1^{#}, except that the electrolyte solution DL12^{#} was used instead. The obtained lithium ion secondary battery was designated as DC12^{#}.

### COMPARATIVE EXAMPLE 13

Preparation of Electrolyte Solution DL13^{#}

The preparation process was the same as that for the electrolyte solution DL1^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as DL13^{#}.

Fabrication of Lithium Ion Secondary Battery DC13^{#}

The fabrication process was the same as that for the lithium ion secondary battery C1^{#}, except that the electrolyte solution DL13^{#} was used instead. The obtained lithium ion secondary battery was designated as DC13^{#}.

### COMPARATIVE EXAMPLE 14

Preparation of Electrolyte Solution DL14^{#}

The preparation process was the same as that for the electrolyte solution DL2^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL14^{#}.

Fabrication of Lithium Ion Secondary Battery DC14^{#}

The fabrication process was the same as that for the lithium ion secondary battery C1^{#}, except that the electrolyte solution DL14^{#} was used instead. The obtained lithium ion secondary battery was designated as DC14^{#}.

### COMPARATIVE EXAMPLE 15

Preparation of Electrolyte Solution DL15^{#}

The preparation process was the same as that for the electrolyte solution DL3^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as DL15^{#}.

Fabrication of Lithium Ion Secondary Battery DC15^{#}

The fabrication process was the same as that for the lithium ion secondary battery C1^{#}, except that the electrolyte solution DL15^{#} was used instead. The obtained lithium ion secondary battery was designated as DC15^{#}.

### COMPARATIVE EXAMPLE 16

Preparation of Electrolyte Solution DL16^{#}

The preparation process was the same as that for the electrolyte solution DL4^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL16^{#}.

Fabrication of Lithium Ion Secondary Battery DC16^{#}

The fabrication process was the same as that for the lithium ion secondary battery C1^{#}, except that the electrolyte solution DL16^{#} was used instead. The obtained lithium ion secondary battery was designated as DC16^{#.}

### COMPARATIVE EXAMPLE 17

Preparation of Electrolyte Solution DL17^{#}

The preparation process was the same as that for the electrolyte solution DL5^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL17^{#}.

Fabrication of Lithium Ion Secondary Battery DC17^{#}

The fabrication process was the same as that for the lithium ion secondary battery C1^{#}, except that the electrolyte solution DL17^{#} was used instead. The obtained lithium ion secondary battery was designated as DC 17^{#}.

### COMPARATIVE EXAMPLE 18

Preparation of Electrolyte Solution DL18^{#}

The preparation process was the same as that for the electrolyte solution DL6^{#}, except that LiPF₆ was replaced by a mixture of LiPF₆ and LiDFOB, and the concentrations of LiPF₆ and LiDFOB in the electrolyte solution were 1 mol L⁻¹ and 0.1 mol L⁻¹ respectively. The obtained electrolyte solution was designated as DL18^{#}.

Fabrication of Lithium Ion Secondary Battery DC18^{#}

The fabrication process was the same as that for the lithium ion secondary battery C1^{#}, except that the electrolyte solution DL18^{#} was used instead. The obtained lithium ion secondary battery was designated as DC18^{#}.

### COMPARATIVE EXAMPLE 19

Preparation of Electrolyte Solution DL19^{#}

The preparation process was the same as that for the electrolyte solution DL7^{#}, except that LiPF₆ was replaced by a mixture of LiPF₆ and LiDFOB, and the concentrations of LiPF₆ and LiDFOB in the electrolyte solution were 1 mol L^{—1} and 0.1 mol L⁻¹ respectively. The obtained electrolyte solution was designated as DL19^{#}.

Fabrication of Lithium Ion Secondary Battery DC19^{#}

The fabrication process was the same as that for the lithium ion secondary battery C1^{#}, except that the electrolyte solution DL19^{#} was used instead. The obtained lithium ion secondary battery was designated as DC19^{#}.

### COMPARATIVE EXAMPLE 20

Preparation of Electrolyte Solution DL20^{#}

The preparation process was the same as that for the electrolyte solution DL8^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL20^{#}.

Fabrication of Lithium Ion Secondary Battery DC20^{#}

The fabrication process was the same as that for the lithium ion secondary battery C1^{#}, except that the electrolyte solution DL20^{#} was used instead. The obtained lithium ion secondary battery was designated as DC20^{#}.

### COMPARATIVE EXAMPLE 21

Preparation of Electrolyte Solution DL21^{#}

The preparation process was the same as that for the electrolyte solution DL9^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL21^{#}.

Fabrication of Lithium Ion Secondary Battery DC21^{#}

The fabrication process was the same as that for the lithium ion secondary battery C1^{#}, except that the electrolyte solution DL21^{#} was used instead. The obtained lithium ion secondary battery was designated as DC21^{#}.

### COMPARATIVE EXAMPLE 22

Preparation of Electrolyte Solution DL22^{#}

The preparation process was the same as that for the electrolyte solution DL10^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL22^{#}.

Fabrication of Lithium Ion Secondary Battery DC22^{#}

The fabrication process was the same as that for the lithium ion secondary battery C1^{#}, except that the electrolyte solution DL22^{#} was used instead. The obtained lithium ion secondary battery was designated as DC22^{#}.

### COMPARATIVE EXAMPLE 23

Preparation of Electrolyte Solution DL23^{#}

The preparation process was the same as that for the electrolyte solution DL11^{#}, except that LiPF₆ was replaced by a mixture of LiPF₆ and LiFSI, and the concentrations of LiPF₆ and LiFSI in the electrolyte solution were 1 mol L⁻¹ and 0.1 mol L⁻¹ respectively. The obtained electrolyte solution was designated as DL23^{#}.

Fabrication of Lithium Ion Secondary Battery DC23^{#}

The fabrication process was the same as that for the lithium ion secondary battery C1^{#}, except that the electrolyte solution DL23^{#} was used instead. The obtained lithium ion secondary battery was designated as DC23^{#}.

### EXAMPLE 40

### Cycling Performance Test of Batteries at High Temperature

The lithium ion secondary batteries C1^{#}-C39^{#} fabricated in Examples 1-39 and the lithium ion secondary batteries DC1^{#}-DC23^{#} fabricated in Comparative Examples 1-23 were tested respectively for the cycling performance at high temperature. Specifically, the process was as follows. The lithium ion secondary battery was charged to 4.2 V at a constant current of 1 C at 60° C. and then charged at a constant voltage of 4.2 V unitil the current was 0.05 C, followed by discharge to 2.8 V at a constant current of 1 C. This was a charge-discharge cycle. The resultant discharge capacity was the discharge capacity of the first cycle. The lithium ion secondary battery was subjected to charge-discharge cycling test following the process above and the discharge capacity of the 300th cycle was obtained.

Capacity retention rate (%) of lithium ion secondary battery after 300 cycles=[discharge capacity of the 300th cycle/discharge capacity of the first cycle]×100%.

The test results for the batteries C1^{#}-C24^{#} and DC1^{#}-DC11^{#} are shown in Table 1, and in table 2 for the batteries C25^{#}-C39^{#} and DC12^{#}-DC23^{#}.

### EXAMPLE 41

### Storage Performance Test of Batteries at High Temperature

The lithium ion secondary batteries C1^{#}-C39^{#} fabricated in Examples 1-39 and the lithium ion secondary batteries DC1^{#}-DC23^{#} fabricated in Comparative Examples 1-23 were tested respectively for the storage performance at high temperature. Specifically, the process was as follows. The battery was charged to 4.2 V at 25° C. at a constant current of 1 C and then further charged at a constant voltage of 4.2 V until the current was 0.05 C, followed by discharge to 2.8 V at a constant current of 1 C. The resultant discharge capacity was the discharge capacity of the battery before storage at high temperature. Subsequently, the battery was charged to 4.2 V at a constant current of 1 C and stored at 60° C. for 30 days. After storage, the battery was placed in an environment of 25° C., and then discharged to 2.8V at a constant current of 0.5 C. Subsequently, the lithium ion secondary battery was charged to 4.2V at a constant current of 1 C, and further charged at a constant voltage of 4.2V until the current was 1 C, followed by discharge to 2.8V at a constant current of 1 C. The last discharge capacity was the discharge capacity of the battery after storage at high temperature.

Capacity retention rate (%) of battery after storage at high temperature=[discharge capacity of lithium ion secondary battery after storage at high temperature/discharge capacity of lithium ion secondary battery before storage at high temperature]×100%.

The test results for the batteries C1^{#}-C24^{#} and DC1^{#}-DC11^{#} are shown in Table 1, and in table 2 for the batteries C25^{#}-C39^{#} and DC12^{#}-DC23^{#}.

### EXAMPLE 42

### DC Resistance Test of Batteries

The lithium ion secondary batteries C1^{#}-C39^{#} fabricated in Examples 1-39 and the lithium ion secondary batteries DC1^{#}-DC23^{#} fabricated in Comparative Examples 1-23 were tested respectively for the DC resistance. Specifically, the process was as follows. The battery was initially charged to 4.2 V at room temperature (25° C.) at a constant current of 0.7 C (1120 mA) and then further charged at a constant voltage of 4.2 V until the current was 0.05 C, followed by discharge to 2.8 V at a constant current of 0.5 C. The resultant discharge capacity of the battery was recorded as C₁. Subsequently, the battery was charged to 4.2 V at a constant current of 1 C and further charged at a constant voltage of 4.2 V until the current was 0.05 C. Then the lithium ion secondary battery was discharged for 48 min at 25° C. at a constant current of 1 C (adjusted to 20% SOC), cooled to −25° C., maintained at this temperature for 2 hrs, and then discharged for 10 s at a constant current of 0.3 C. The voltages before and after the 10 s discharge were recorded as U1 and U2. The DC resistance (DCR) was calculated by a formula below:

DC resistance (DCR)=(U1−U2)/0.3 C.

The test results for the batteries C1^{#}-C24^{#} and DC1^{#}-DC11^{#} are shown in Table 1, and in table 2 for the batteries C25^{#}-C39^{#} and DC12^{#}-DC23^{#}.

TABLE 1

| | | | Species of | | | |
|---|---|---|---|---|---|---|
| | Species of additives, and contents in electrolyte solution, | | lithium salts, | Capacity | Capacity | |
| | wt % | | and | retention | retention | |
| | | Cyclic | concentration | rate | rate | |
| | | sulfate | in | upon | upon | DC |
| Battery | | ester | electrolyte | cycling | storage | resistance |
| No. | Naphthalene compound with amino group | compound | solution | (%) | (%) | (mΩ) |
| C1^{#} | 1,8-bis(dimethylamino)naphthalene, 0.03% | Ethylene | LiPF₆, 1 mol/L | 76 | 77 | 719 |
| | | sulfate, | | | | |
| | | 1% | | | | |
| C2^{#} | 1,8-bis(dimethylamino)naphthalene, 0.1% | Ethylene | LiPF₆, 1 mol/L | 78 | 79 | 725 |
| | | sulfate, | | | | |
| | | 1% | | | | |
| C3^{#} | 1,8-bis(dimethylamino)naphthalene, 0.5% | Ethylene | LiPF₆, 1 mol/L | 80 | 81 | 746 |
| | | sulfate, | | | | |
| | | 1% | | | | |
| C4^{#} | 1,8-bis(dimethylamino)naphthalene, 1% | Ethylene | LiPF₆, 1 mol/L | 84 | 86 | 775 |
| | | sulfate, | | | | |
| | | 1% | | | | |
| C5^{#} | 1,8-bis(dimethylamino)naphthalene, 3% | Ethylene | LiPF₆, 1 mol/L | 85 | 86 | 802 |
| | | sulfate, | | | | |
| | | 1% | | | | |
| C6^{#} | 1,8-bis(dimethylamino)naphthalene, 0.03% | Propylene | LiPF₆, 1 mol/L | 80 | 81 | 722 |
| | | sulfate, | | | | |
| | | 1% | | | | |
| C7^{#} | 1,8-bis(dimethylamino)naphthalene, 0.1% | Propylene | LiPF₆, 1 mol/L | 80 | 81 | 722 |
| | | sulfate, | | | | |
| | | 1% | | | | |
| C8^{#} | 1,8-bis(dimethylamino)naphthalene, 0.5% | Propylene | LiPF₆, 1 mol/L | 82 | 84 | 748 |
| | | sulfate, | | | | |
| | | 1% | | | | |
| C9^{#} | 1,8-bis(dimethylamino)naphthalene, 1% | Propylene | LiPF₆, 1 mol/L | 83 | 85 | 779 |
| | | sulfate, | | | | |
| | | 1% | | | | |
| C10^{#} | 1,8-bis(dimethylamino)naphthalene, 3% | Propylene | LiPF₆, 1 mol/L | 85 | 86 | 804 |
| | | sulfate, | | | | |
| | | 1% | | | | |
| C11^{#} | 1,8-bis(dimethylamino)naphthalene, 0.5% | Ethylene | LiPF₆, 1 mol/L | 76 | 77 | 705 |
| | | sulfate, | | | | |
| | | 0.1% | | | | |
| C12^{#} | 1,8-bis(dimethylamino)naphthalene, 0.5% | Ethylene | LiPF₆, 1 mol/L | 79 | 80 | 731 |
| | | sulfate, | | | | |
| | | 0.5% | | | | |
| C13^{#} | 1,8-bis(dimethylamino)naphthalene, 0.5% | Ethylene | LiPF₆, 1 mol/L | 82 | 84 | 775 |
| | | sulfate, | | | | |
| | | 3% | | | | |
| C14^{#} | 1,8-bis(dimethylamino)naphthalene, 0.5% | Ethylene | LiPF₆, 1 mol/L | 85 | 87 | 816 |
| | | sulfate, | | | | |
| | | 5% | | | | |
| C15^{#} | 1,8-bis(dimethylamino)naphthalene, 0.5% | Butylene | LiPF₆, 1 mol/L | 80 | 81 | 751 |
| | | sulfate, | | | | |
| | | 1% | | | | |
| C16^{#} | 1,8-bis(diethylamino)naphthalene, 0.5% | Ethylene | LiPF₆, 1 mol/L | 81 | 81 | 753 |
| | | sulfate, | | | | |
| | | 1% | | | | |
| C17^{#} | 1,8-bis(dipropylamino)naphthalene, 0.5% | Ethylene | LiPF₆, 1 mol/L | 81 | 81 | 749 |
| | | sulfate, | | | | |
| | | 1% | | | | |
| C18^{#} | 1,2-bis(dimethylamino)naphthalene, 0.5% | Ethylene | LiPF₆, 1 mol/L | 78 | 78 | 718 |
| | | sulfate, | | | | |
| | | 1% | | | | |
| C19^{#} | 1,7-bis(dimethylamino)naphthalene, 0.5% | Ethylene | LiPF₆, 1 mol/L | 77 | 80 | 733 |
| | | sulfate, | | | | |
| | | 1% | | | | |
| C20^{#} | 1,2,6-tris(methylamino)naphthalene, 0.5% | Ethylene | LiPF₆, 1 mol/L | 77 | 79 | 735 |
| | | sulfate, | | | | |
| | | 1% | | | | |
| C21^{#} | 2,3,6,7-tetrakis(methylamino)naphthalene, | Ethylene | LiPF₆, 1 mol/L | 76 | 78 | 735 |
| | 0.5% | sulfate, | | | | |
| | | 1% | | | | |
| C22^{#} | 1-monoaminonaphthalene, 0.5% | Ethylene | LiPF₆, 1 mol/L | 77 | 77 | 716 |
| | | sulfate, | | | | |
| | | 1% | | | | |
| C23^{#} | 1,2,3,5,8-pentakis(methylamino)naphthalene, | Ethylene | LiPF₆, 1 mol/L | 78 | 77 | 725 |
| | 0.5% | sulfate, | | | | |
| | | 1% | | | | |
| C24^{#} | 1,2,3,4,5,6,7,8-octakis(methylamino)naphthalene, | Ethylene | LiPF₆, 1 mol/L | 77 | 78 | 720 |
| | 0.5% | sulfate, | | | | |
| | | 1% | | | | |
| DC1^{#} | No | No | LiPF₆, 1 mol/L | 70 | 70 | 654 |
| DC2^{#} | No | Ethylene | LiPF₆, 1 mol/L | 74 | 75 | 714 |
| | | sulfate, | | | | |
| | | 1% | | | | |
| DC3^{#} | No | Propylene | LiPF₆, 1 mol/L | 75 | 75 | 713 |
| | | sulfate, | | | | |
| | | 1% | | | | |
| DC4^{#} | 1,8-bis(dimethylamino)naphthalene, | Ethylene | LiPF₆, 1 mol/L | 76 | 76 | 712 |
| | 0.005% | sulfate, | | | | |
| | | 1% | | | | |
| DC5^{#} | 1,8-bis(dimethylamino)naphthalene, 5% | Ethylene | LiPF₆, 1 mol/L | 78 | 77 | 855 |
| | | sulfate, | | | | |
| | | 1% | | | | |
| DC6^{#} | 1,8-bis(dimethylamino)naphthalene, | Propylene | LiPF₆, 1 mol/L | 76 | 76 | 711 |
| | 0.005% | sulfate, | | | | |
| | | 1% | | | | |
| DC7^{#} | 1,8-bis(dimethylamino)naphthalene, 5% | Propylene | LiPF₆, 1 mol/L | 77 | 79 | 864 |
| | | sulfate, | | | | |
| | | 1% | | | | |
| DC8^{#} | 1,8-bis(dimethylamino)naphthalene, 0.5% | Ethylene | LiPF₆, 1 mol/L | 74 | 75 | 687 |
| | | sulfate, | | | | |
| | | 0.001% | | | | |
| DC9^{#} | 1,8-bis(dimethylamino)naphthalene, 0.5% | Ethylene | LiPF₆, 1 mol/L | 85 | 87 | 917 |
| | | sulfate, | | | | |
| | | 8% | | | | |
| DC10^{#} | 1,8-bis(dimethylamino)naphthalene, 0.5% | Vinylene | LiPF₆, 1 mol/L | 81 | 80 | 954 |
| | | carbonate, | | | | |
| | | 1% | | | | |
| DC11^{#} | 1,8-bis(dimethylamino)naphthalene, 0.5% | No | LiPF₆, 1 mol/L | 75 | 75 | 675 |

TABLE 2

| | | | Species of | Capacity | Capacity | |
|---|---|---|---|---|---|---|
| | | | lithium salts, | retention | retention | |
| | Species of additives, and contents in | | and | rate | rate | |
| | electrolyte solution, wt % | | concentration | upon | upon | DC |
| Battery | Naphthalene compound with amino | Cyclic sulfate | in electrolyte | cycling | storage | resistance |
| No. | group | ester compound | solution | (%) | (%) | (mΩ) |
| C25^{#} | 1,8-bis(dimethylamino)naphthalene | Ethylene sulfate | LiPF₆, 1 mol/L | 80 | 80 | 643 |
| | 0.03% | 1% | LiFSI, 0.1 mol/L | | | |
| C26^{#} | 1,8-bis(dimethylamino)naphthalene | Ethylene sulfate | LiPF₆, 1 mol/L | 82 | 83 | 682 |
| | 0.10% | 1% | LiFSI, 0.1 mol/L | | | |
| C27^{#} | 1,8-bis(dimethylamino)naphthalene | Ethylene sulfate | LiPF₆, 1 mol/L | 84 | 85 | 700 |
| | 0.50% | 1% | LiFSI, 0.1 mol/L | | | |
| C28^{#} | 1,8-bis(dimethylamino)naphthalene | Ethylene sulfate | LiPF₆, 1 mol/L | 88 | 90 | 730 |
| | 1% | 1% | LiFSI, 0.1 mol/L | | | |
| C29^{#} | 1,8-bis(dimethylamino)naphthalene | Ethylene sulfate | LiPF₆, 1 mol/L | 89 | 90 | 756 |
| | 3% | 1% | LiFSI, 0.1 mol/L | | | |
| C30^{#} | 1,8-bis(dimethylamino)naphthalene | Propylene sulfate | LiPF₆, 1 mol/L | 80 | 81 | 668 |
| | 0.03% | 1% | LiDFOB, 0.1 mol/L | | | |
| C31^{#} | 1,8-bis(dimethylamino)naphthalene | Propylene sulfate | LiPF₆, 1 mol/L | 84 | 85 | 672 |
| | 0.10% | 1% | LiDFOB, 0.1 mol/L | | | |
| C32^{#} | 1,8-bis(dimethylamino)naphthalene | Propylene sulfate | LiPF₆, 1 mol/L | 86 | 88 | 704 |
| | 0.50% | 1% | LiDFOB, 0.1 mol/L | | | |
| C33^{#} | 1,8-bis(dimethylamino)naphthalene | Propylene sulfate | LiPF₆, 1 mol/L | 87 | 89 | 730 |
| | 1% | 1% | LiDFOB, 0.1 mol/L | | | |
| C34^{#} | 1,8-bis(dimethylamino)naphthalene | Propylene sulfate | LiPF₆, 1 mol/L | 89 | 90 | 758 |
| | 3% | 1% | LiDFOB, 0.1 mol/L | | | |
| C35^{#} | 1,8-bis(dimethylamino)naphthalene | Ethylene sulfate | LiPF₆, 1 mol/L | 81 | 82 | 659 |
| | 0.50% | 0.10% | LiFSI, 0.1 mol/L | | | |
| C36^{#} | 1,8-bis(dimethylamino)naphthalene | Ethylene sulfate | LiPF₆, 1 mol/L | 83 | 84 | 689 |
| | 0.50% | 0.50% | LiFSI, 0.1 mol/L | | | |
| C37^{#} | 1,8-bis(dimethylamino)naphthalene | Ethylene sulfate | LiPF₆, 1 mol/L | 86 | 87 | 726 |
| | 0.50% | 3% | LiFSI, 0.1 mol/L | | | |
| C38^{#} | 1,8-bis(dimethylamino)naphthalene | Ethylene sulfate | LiPF₆, 1 mol/L | 88 | 89 | 753 |
| | 0.50% | 5% | LiFSI, 0.1 mol/L | | | |
| C39^{#} | 1,8-bis(dimethylamino)naphthalene | Butylene sulfate | LiPF₆, 1 mol/L | 82 | 83 | 701 |
| | 0.50% | 1% | LiFSI, 0.1 mol/L | | | |
| DC12^{#} | No | No | LiPF₆, 1 mol/L | 71 | 71 | 614 |
| | | | LiFSI, 0.1 mol/L | | | |
| DC13^{#} | No | No | LiPF₆, 1 mol/L | 71 | 72 | 665 |
| | | | LiDFOB, 0.1 mol/L | | | |
| DC14^{#} | No | Ethylene sulfate | LiPF₆, 1 mol/L | 75 | 76 | 668 |
| | | 1% | LiFSI, 0.1 mol/L | | | |
| DC15^{#} | No | Propylene sulfate | LiPF₆, 1 mol/L | 78 | 79 | 665 |
| | | 1% | LiDFOB, 0.1 mol/L | | | |
| DC16^{#} | 1,8-bis(dimethylamino)naphthalene | Ethylene sulfate | LiPF₆, 1 mol/L | 78 | 78 | 670 |
| | 0.005% | 1% | LiFSI, 0.1 mol/L | | | |
| DC17^{#} | 1,8-bis(dimethylamino)naphthalene | Ethylene sulfate | LiPF₆, 1 mol/L | 78 | 78 | 814 |
| | 5% | 1% | LiFSI, 0.1 mol/L | | | |
| DC18^{#} | 1,8-bis(dimethylamino)naphthalene | Propylene sulfate | LiPF₆, 1 mol/L | 80 | 79 | 667 |
| | 0.005% | 1% | LiDFOB, 0.1 mol/L | | | |
| DC19^{#} | 1,8-bis(dimethylamino)naphthalene | Propylene sulfate | LiPF₆, 1 mol/L | 78 | 78 | 814 |
| | 5% | 1% | LiDFOB, 0.1 mol/L | | | |
| DC20^{#} | 1,8-bis(dimethylamino)naphthalene | Ethylene sulfate | LiPF₆, 1 mol/L | 73 | 74 | 658 |
| | 0.50% | 0.001% | LiFSI, 0.1 mol/L | | | |
| DC21^{#} | 1,8-bis(dimethylamino)naphthalene | Ethylene sulfate | LiPF₆, 1 mol/L | 88 | 89 | 844 |
| | 0.50% | 8% | LiFSI, 0.1 mol/L | | | |
| DC22^{#} | 1,8-bis(dimethylamino)naphthalene | Vinylene | LiPF₆, 1 mol/L | 85 | 84 | 907 |
| | 0.50% | carbonate | LiFSI, 0.1 mol/L | | | |
| | | 1% | | | | |
| DC23^{#} | 1,8-bis(dimethylamino)naphthalene | No | LiPF₆, 1 mol/L | 73 | 74 | 634 |
| | 0.50% | | LiFSI, 0.1 mol/L | | | |

It can be seen from comparison of the lithium ion secondary batteries C1^{#}-C17^{#} with DC1^{#}-DC3^{#} that after ethylene sulfate or propylene sulfate is added to the electrolyte solution, the capacity retention rate upon cycling and storage of the batteries is obviously increased, as compared with the electrolyte solution without any additives added. After 1,8-bis(dimethylamino)naphthalene is added to the electrolyte solution, the capacity retention rate upon cycling and storage of the batteries is further increased. With increasing content (from 0.03% to 3%) of 1,8-bis(dimethylamino)naphthalene, the capacity retention rate upon cycling and storage of the batteries is accordingly increased. It can be seen from DC4^{#}-DC7^{#} that when the content of the additive 1,8-bis(dimethylamino)naphthalene is low (0.05%), the battery performance is insignificantly improved. Furthermore, when the content of the additive 1,8-bis(dimethylamino)naphthalene is too high (5%), the battery performance is also insignificantly improved, because 1,8-bis(dimethylamino)naphthalene, due to its basic nature, trends to bind to phosphorus pentafluoride, inducing the decomposition of lithium hexafluorophosphate, and high content of 1,8-bis(dimethylamino)naphthalene causes the viscosity of the electrolyte solution to increase. It can be seen from C11^{#}-C14^{#} that with the content of the additive 1,8-bis(dimethylamino)naphthalene unchanged, the capacity retention rate upon cycling and storage of the batteries is accordingly increased with increasing content (from 0.1% to 5%) of ethylene sulfate. However, when the content of the additive is too low (DC8^{#}), there is no obvious improvement, and when the content is too high (DC9^{#}), the viscosity of the electrolyte solution is caused to increase, resulting in the increase of the internal resistance. It can be seen from comparison of C3^{#} with DC10^{#} that as compared with the situation where 1% of vinylene carbonate is added, the discharge resistance at low temperature of the batteries with the same content of ethylene sulfate added is obviously reduced (from 954 mΩ to 746 mΩ), suggesting that the cyclic sulfate ester has the advantage of low film-forming impedance. It can be seen from comparison of C15^{#} with DC11^{#} that the electrolyte solution containing butylene sulfate also has the function of improving the cycling and storage performances. It can be seen from C16^{#} and C17^{#} that similar to 1,8-bis(dimethylamino)naphthalene, 1,8-bis(diethylamino)naphthalene and 1,8-bis(dipropylamino)naphthalene also have the function of improving the cycling and storage performances at high temperature. It can be seen from C18^{#} to C24^{#} that as compared with the electrolyte solution having 1,8-bis(dimethylamino)naphthalene added, the addition of 1,2-bis(dimethylamino)naphthalene, 1,7-bis(dimethylamino)naphthalene, 1,2,6-tris(methylamino)naphthalene, 2,3,6,7-tetrakis(methylamino)naphthalene, 1-monoaminonaphthalene, 1,2,3,5,8-pentakis(methylamino)naphthalene, 1,2,3,4,5,6,7,8-octakis(methylamino)naphthalene, and other amino naphthalene compounds also have similar function of improving the cycling and storage performances.

In addition to LiPF₆, a second lithium salt ingredient LiFSI or LiDFOB is further added to the electrolyte solution of C25^{#}-C39^{#}, compared with C1^{#}-C17^{#}. After 0.1 mol L⁻¹ of LiFSI or LiDFOB is added to the electrolyte solution, the capacity retention rate upon cycling and storage of the batteries is increased to some extent, and the discharge resistance at low temperature is reduced somewhat (C3^{#} and C27^{#}). Moreover, after varying concentrations of 1,8-bis(dimethylamino)naphthalene is added to the electrolyte solution containing LiFSI or LiDFOB, the capacity retention rate upon cycling and storage of the batteries is further increased. It can be seen from C25^{#}-C29^{#} that with increasing content of 1,8-bis(dimethylamino)naphthalene in the electrolyte solution containing LiFSI and ethylene sulfate, the capacity retention rate upon cycling and storage of the batteries is accordingly increased. It can be seen from DC16^{#} and DC17^{#} that there is no obvious contribution to the improvement of the battery performances if the content of the additive 1,8-bis(dimethylamino)naphthalene is too high or too low. It can be seen from C35^{#}-C39^{#} that with the content of the additive 1,8-bis(dimethylamino)naphthalene unchanged, the capacity retention rate upon cycling and storage of the batteries is increased with increasing concentrations of ethylene sulfate. It can be seen from DC20^{#} and DC21^{#} that where the content of the cyclic sulfate ester is too low, there is no obvious improvement, and where the content of the cyclic sulfate ester is too high, the capacity retention rate upon cycling and storage is not increased, but the internal resistance is elevated. It can be seen from comparison of C27^{#} with DC22^{#} that the batteries with ethylene sulfate as a film-forming additive have a much lower discharge resistance at low temperature than batteries with a film-forming additive containing carbon-carbon double bond, i.e. vinylene carbonate (VC), with the cycling and storage performances at high temperature unaffected.

It can be seen from comparison of lithium ion secondary batteries C1^{#}-C17^{#} with C18^{#}-C24^{#} that the capacity retention rate upon storage of C18^{#} is relatively poor because the diamino naphthalene added is one having an asymmetric structure; since the amino naphthalene compounds added to C19^{#}-C24^{#} are those having one or more amino groups in their structure, the capacity retention rate upon storage is also relatively lower than that of C1^{#}-C17^{#} having diamino naphthalene compounds of symmetric structure added. The underlying reason may be that the diamino naphthalene compounds having 1,8-symmetric structure can improve the cycling and storage performances at high temperature of the batteries more effectively.

It can be seen from the experimental results above that after the film-forming additive ethylene sulfate or propylene sulfate, the low impedance lithium salt LiFSI or LiDFOB, and the hydrogen fluoride capturing agent 1,8-bis(dimethylamino)naphthalene are added to the electrolyte solution, the cycling and storage performances at high temperature of the batteries are obviously improved, and the discharge resistance at low temperature is lower, which are more desirable to the electrolyte solution of power batteries.

It should be noted that although in the examples of this specification, the additive in the electrolyte solution for lithium ion secondary batteries provided this application is described merely with several amino naphthalene compounds as examples, the additive in the electrolyte solution for lithium ion secondary batteries may also be one additional or a mixture of two or more additional amino naphthalene compounds according to other embodiments of the lithium ion secondary battery provided in this application.

The descriptions above are merely several examples of this application and are not intended to limit this application in any way. Although this application is disclosed as above with preferred examples, this application is not limited thereto. Any variations or modifications made by those skilled in the art based on the disclosed technical contents without departing from the scope of the technical solution of this application are contemplated as equivalent implementations, and fall within the scope of the technical solution.

1. An electrolyte solution, comprising a non-aqueous organic solvent, a lithium salt, and additives, wherein the additives comprise:
a cyclic sulfate ester compound; and
a naphthalene compound with amino group.

2. The electrolyte solution according to claim 1, wherein the cyclic sulfate ester compound is selected from at least one of the compounds having a chemical structure as shown in Formulas I, II, III, and IV: 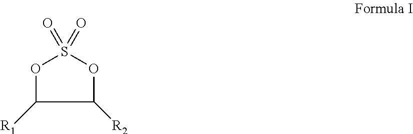
wherein R₁ is hydrogen or selected from a C₁₋₁₀ alkyl group; and R₂ is hydrogen or selected from a C₁₋₁₀ alkyl group; 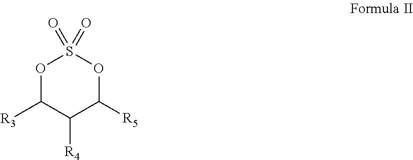
wherein R₃ is hydrogen or selected from a C₁₋₁₀ alkyl group; R₄ is hydrogen or selected from a C₁₋₁₀ alkyl group; and R₅ is hydrogen or selected from a C₁₋₁₀ alkyl group; 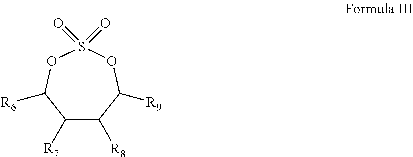
wherein R₆ is hydrogen or selected from a C₁₋₁₀ alkyl group; R₇ is hydrogen or selected from a C₁₋₁₀ alkyl group; R₈ is hydrogen or selected from a C₁₋₁₀ alkyl group; and R₉ is hydrogen or selected from a C₁₋₁₀ alkyl group; and 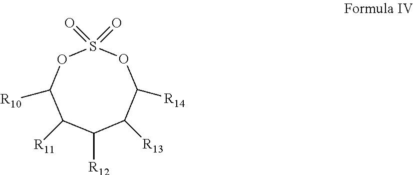
wherein R₁₀ is hydrogen or selected from a C₁₋₁₀ alkyl group; R₁₁ is hydrogen or selected from a C₁₋₁₀ alkyl group; R₁₂ is hydrogen or selected from a C₁₋₁₀ alkyl group; R₁₃ is hydrogen or selected from a C₁₋₁₀ alkyl group; and R₁₄ is hydrogen or selected from a C₁₋₁₀ alkyl group.

3. The electrolyte solution according to claim 2, wherein the cyclic sulfate ester compound is selected from at least one of the compounds having a chemical structure as shown in Formula I.

4. The electrolyte solution according to claim 1, wherein the cyclic sulfate ester compound is selected from at least one of ethylene sulfate, propylene sulfate, and butylene sulfate.

5. The electrolyte solution according to claim 1, wherein the cyclic sulfate ester compound is present in the electrolyte solution in an amount of 0.01-5% by weight.

6. The electrolyte solution according to claim 1, wherein the naphthalene compound with amino group is selected from at least one of the compounds having a chemical structure as shown in Formula V: 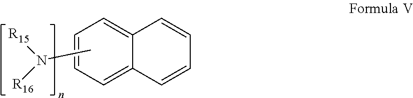
wherein R₁₅ is selected from a C₁₋₁₀ alkyl group; R₁₆ is selected from a C₁₋₁₀ alkyl group; and n is any positive integer selected from 1 to 8.

7. The electrolyte solution according to claim 1, wherein the naphthalene compound with amino group is selected from at least one of 1,8-bis(dimethylamino)naphthalene, 1,8-bis(diethylamino)naphthalene, 1,8-bis(dipropylamino)naphthalene, 1,2-bis(dimethylamino)naphthalene, 1,7-bis(dimethylamino)naphthalene, 1,2,6-tris(methylamino)naphthalene, 2,3,6,7-tetrakis(methylamino)naphthalene, 1-monoaminonaphthalene, 1,2,3,5,8-pentakis(methylamino)naphthalene, and 1,2,3,4,5,6,7,8-octakis(methylamino)naphthalene.

8. The electrolyte solution according to claim 1, wherein the naphthalene compound with amino group is present in the electrolyte solution in an amount of 0.01-3% by weight.

9. The electrolyte solution according to claim 1, wherein the lithium salt comprises lithium hexafluorophosphate.

10. A lithium ion battery, comprising the electrolyte solution[s] according to claim 1.

11. A lithium ion battery, comprising the electrolyte solution[s] according to claim 2.

12. A lithium ion battery, comprising the electrolyte solution[s] according to claim 3.

13. A lithium ion battery, comprising the electrolyte solution[s] according to claim 4.

14. A lithium ion battery, comprising the electrolyte solution[s] according to claim 5.

15. A lithium ion battery, comprising the electrolyte solution[s] according to claim 6.

16. A lithium ion battery, comprising the electrolyte solution[s] according to claim 7.

17. A lithium ion battery, comprising the electrolyte solution[s] according to claim 8.

18. A lithium ion battery, comprising the electrolyte solution[s] according to claim 9.
